(19) United States
(12) Patent Application Publication
(10) Pub. No.: US 2024/0126831 A1
(43) Pub. Date: Apr. 18, 2024

(54) Depth-wise convolution accelerator using MAC array processor structure

(71) Applicant: NEOWINE Co., Ltd., Seongnam-si (KR)

(72) Inventors: Hyo Seung LEE, Seongnam-si (KR); Seen Suk KANG, Seongnam-si (KR); Sang Gil CHOI, Seongnam-si (KR); Seang Hoon KIM, Gwangju-si (KR); Yong Wook KWON, Yongin-si (KR)

(21) Appl. No.: 18/380,637

(22) Filed: Oct. 16, 2023

(30) Foreign Application Priority Data
Oct. 18, 2022 (KR) 10-2022-0134321

(51) Int. Cl. G06F 17/15; G06F 7/544

(52) U.S. Cl. CPC G06F 17/15; G06F 7/5443

(57) ABSTRACT

A depth-wise convolution acceleration device using an MAC array processor structure according to the present invention may include a data output unit, which receives a data of each row of the image from the data buffer and inputs the data into convolution operation blocks while shifting the data N−1 times according to the kernel size (N×N) and a weight output unit, which receives the kernel data from the kernel buffer and sequentially inputs a weight value constituting the kernel data to each of the row convolution operation blocks, and inputs the weight delaying by N clocks if the row increases as N rows.

### CROSS-REFERENCE TO RELATED APPLICATION

The present application claims priority to Korean Patent Application No. 10-2022-0134321, filed on Oct. 18, 2022, in the Korean Intellectual Property Office, which is incorporated herein in its entirety by reference.

### TECHNICAL FIELD

The present invention is related to a depth-wise convolution accelerator using a MAC array processor structure or architecture.

### BACKGROUND OF INVENTION

There are about 100 types of artificial intelligence operators for image processing, but more than 90% of artificial intelligence operations consist of convolution.

As shown in FIG. 1, convolution is generally calculated by adding the values of each pixel value of an image (I) multiplied by each value of the kernel (K).

Referring to FIG. 1, a process in which an image of size 7×7 is convolved by a kernel of size 3×3 and an output as a feature map of size 5×5 is shown.

Since there are many types of kernels, filters, in most convolutions, reading the same image data and processing multiple types of filter values at once is very efficient in terms of data read operation.

When this convolution is processed in hardware, it is processed in an accelerating device having a Multiply accumulate (MAC) array processor architecture. Among artificial intelligence accelerators, most Neural Processing Units (NPUs) for Convolution Neural Network (CNN) use a MAC array processor structure.

MAC array processors are also designed with a systolic array architecture, and are also designed with a vector processing method where input data is simultaneously input to all columns or rows.

In the case of a vector processing method, data inputted at a top of the array architecture is simultaneously inputted to all processors on the column as pixel data of an image.

Similarly, the weight input from the left side of the array structure (called weight instead of filter value in NPU) is where values corresponding to various types of kernels are inputted, and the same weight is simultaneously inputted to all processors in the same row.

Therefore, in a MAC array processor architecture, it is common for processors in the same column to process the same image data, and processors in the same row to perform arithmetic processing on the same filter value.

Convolution is broadly divided into convolution 3d, convolution 1×1, and depth-wise convolution.

Convolution 3d and Convolution 1×1 are efficiently processed on MAC array processors because multiple types of kernels are used for one image and the computational processing is similar. However, MAC array processor architecture is not suitable for depth-wise convolution because only one kernel is used for one image.

That is, since depth-wise convolution is an operation in which one filter corresponds one to one image, different filter values cannot be input for each row, so the MAC array processor architecture is not very suitable. Accordingly, a depth-wise convolution as a separate accelerator is used for designing the most NPUs.

For example, in a conventional NPU, 96 processors are implemented for depth-wise convolution separately from the 32×32 MAC array processor. In this case, there is a disadvantage that the area of the chip is increased by adding a separate operation logic circuit, and the chip price is increased and the power consumption is increased accordingly.

### RELATED ART(S)

### Patent Document

(Patent Document 1) Korean Patent Publication No. 10-2022-0009483.

### DESCRIPTION OF THE INVENTION

### Problems to be Solved

The present invention is for solving the above problems, and the purpose of the present invention is to implement a depth-wise convolution accelerating device with a conventional MAC array processor architecture without adding a depth-wise convolution logic.

### Means for Solving the Problems

The depth-wise convolution accelerating device using the MAC array processor architecture according to an aspect of the present invention may include: a data output unit that receives the data of each row of the image from a data buffer and shifts N−1 times according to the kernel size (N×N) while inputting the data to the convolution operation blocks and a weight output unit which receives the kernel data from the kernel buffer and sequentially inputs weights constituting the kernel data to each of the row convolution operation blocks, and inputs delayed by N clocks as the rows increase.

A MAC array processor according to aspect(s) of the present invention, the same image data may be simultaneously inputted to convolution operation blocks in the same column, the same kernel data may be inputted to the convolution operation blocks in the same row, and the kernel data may be inputted to the convolution operation blocks in each row delayed than the convolution operation blocks in the previous row by N clocks according to the kernel size (N×N).

### Effects of the Invention

As described above, the present invention implements an acceleration device by using an existing MAC array processor structure without adding a separate depth-wise convolution logic, thereby reducing chip surface area, reducing chip costs, and reducing power consumption.

In addition, the depth-wise convolution logic implemented as a separate processor has been applied only to a kernel of a specific size, but aspect(s) of the present invention can realize a depth-wise convolution without limiting the size of the kernel, thereby being very excellent in terms of performance.

### BRIEF EXPLANATION OF THE DRAWINGS

FIG. 1 is a diagram for describing a general convolution operation.

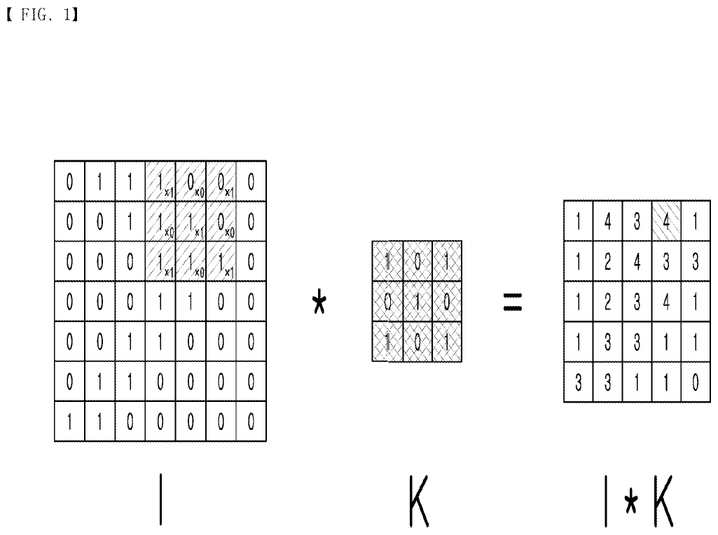

FIG. 2 is a diagram illustrating a configuration of a depth-wise convolution acceleration device using a MAC array processor structure according to an aspect of the present invention.

FIG. 3 is a diagram showing the configuration of a data output unit and a weighted value output unit in a depth-wise convolution acceleration device using a MAC array processor architecture according to an aspect of the present invention.

FIG. 4 is a diagram illustrating a detailed internal configuration of the weight output unit according to an aspect of the present invention.

FIG. 5 is a diagram illustrating an internal configuration of the weight output block according to an aspect of the present invention.

### DETAILED INVENTION DISCLOSURES

Hereinafter, embodiments according to the present invention will be described in detail with reference to the accompanying drawings. The configuration of the present invention and the effects thereof will be clearly understood through the following detailed description.

Prior to the detailed description of the present invention, it is noted that the same components are displayed with the same code as possible even if they are displayed on other drawings, and that specific descriptions will be omitted when it is determined that the gist of the present invention may be blurred with respect to known configurations.

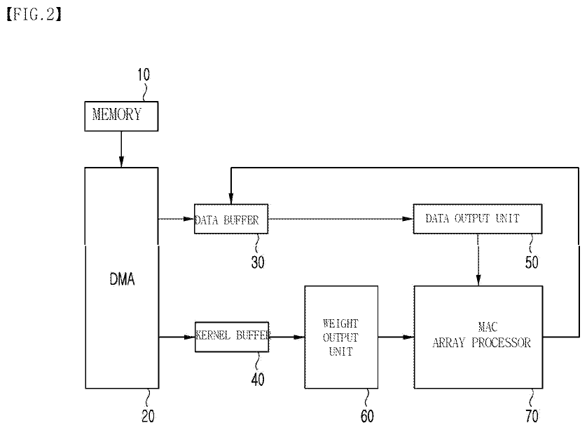

FIG. 2 illustrates a configuration of a depth-wise convolution accelerating device using a MAC array processor architecture according to an aspect of the present invention.

Referring to FIG. 2, the direct memory access (DMA) 20 may call, i.e., read, the input image and the kernel data stored in the memory 10 and temporarily store the input image and the kernel data in the image data buffer 30 and the kernel buffer 40, respectively.

An input data of the convolution may include M image data and N kernel data. If the kernel data maintains the same value for one image as a whole, and convolution may be performed with a 3×3 kernel, the kernel data may have 9 weights.

If convolution is performed with N kernel data for one image is a general convolution, it is a depth-wise convolution to perform convolution only for one image and one kernel corresponding to it.

Aspect(s) of the present invention may implement such depth-wise convolution using a MAC array processor structure rather than a separate logic structure.

That is, a data output unit 50 may be arranged with a column of the MAC array processor 70 and a weight output unit 60 may be arranged with a row of the MAC array processor 70 to implement a depth-wise convolution acceleration device according to an aspect(s) of the present invention.

The data output unit 50 may receive data of each row of the image from the data buffer 30 and output a pixel value in a column direction of the MAC array processor 70. When outputting the pixel value, the data output unit 50 may shift the pixel value of the image data N−1 according to the kernel size N×N.

The weight output unit 60 may receive the kernel data from the kernel buffer 40 and output the weight in the row direction of the MAC array processor 70. When the weights are sequentially output from each row of the weight output unit 60, the row increases as an N rows and the weights are continuously output delayed by N clocks.

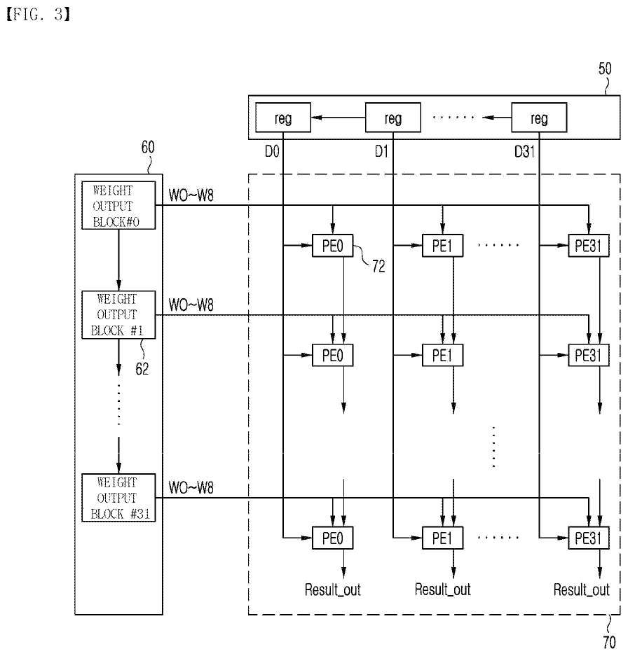

FIG. 3 illustrates a configuration of a data output unit and a weight output unit in a depth-wise convolution device using a MAC array processor structure according to the present invention.

Referring to FIG. 3, a data output unit 50 may include a plurality of shift registers arranged for each column to simultaneously receive and shift data of each row of an image, and a weight output unit 60 may include a plurality of weight output blocks (62) arranged for each row to receive kernel data and output the kernel data in a FIFO method.

The MAC array processor 70 may include a plurality of convolutional computation blocks, processor element (PE), 72 such that the same image data is simultaneously input to the convolutional computation blocks 72 in the same column, and the same kernel data is input to the convolutional computation blocks 72 in the same row.

In this case, a kernel data is inputted to the convolution operation blocks 72 in each row delayed by N clock than the convolution operation blocks of the previous row according to a kernel size N×N.

An operation of the depth-wise convolution accelerator according to the present invention is detailly described. First, data of each row of an image is loaded from a data buffer 30 to a shift register of a data output unit 50 in 32 units (D0-D31).

The loaded data may be inputted to the MAC array processor 70 by shifting 2 times if a kernel size is 3×3, 4 times if a kernel size is 5×5, and 6 times if a kernel size is 7×7. According to an embodiment of the present invention, since the kernel size is 3×3, two shifts may be performed.

Thereafter, data of the row is input in the same method, and in case of a kernel size 3×3, data of 3 rows, a kernel size 5×5, data of 5 rows, and a kernel size 7×7 data of 7 rows may be inputted. In an embodiment of the present invention, since the kernel size is 3×3, three row data may be inputted.

According to the convolution operation block PE0, data is inputted in the order of D1, . . . D8, W1, and W8 through three row data inputs from the data output unit 50 and two shifts for each row data, and as W0, W1, . . . W8 are sequentially input from the weight output unit 60, Dn×Wn operation and accumulation are performed in PE0 to store the C0 value as shown in Equation 1.

C0=W0×D0+W1×D1+ . . . +W8×D8 [Equation 1]

In the same way, the depth-wise convolution for the first row is completed by storing a C1 value to a C31 value are stored in PE1 to PE31, respectively.

In the next second row of PE0, W0, W1, . . . W8 are sequentially input delayed by three clocks, and the weight is inputted delayered by three clocks as the row is continuously increased below it.

That is, the weight is inputted delayed by 3 clocks in the second row PE0, by 6 clocks in the third row PE0, and by 9 clocks in the fourth row PE0, respectively.

If a kernel size is 5×5, an input of the weight may be delayed by 5 clocks, and if the kernel size is 7×7, an input of the weight may be delayed by 7 clocks. For example, when the kernel size is 5×5, an input of weight may be delayed by 5 clocks in PE0 of the second row, 10 clocks in PE0 of the third row, and 15 clocks in PE0 of the fourth row, respectively.

In addition, before the W0 value is input in each PE or after the W8 value is input, the 0 value is input, so it does not affect the value stored in the PE.

In this way, the image data is sequentially input for each row, the weight is delayed as the row increases, and when the input is completed, the accumulated value (Cn) is stored in each PEn, and then the Cn value is shifted and stored in the data buffer 30, and the 32×32 depth-wise convolution is completed.

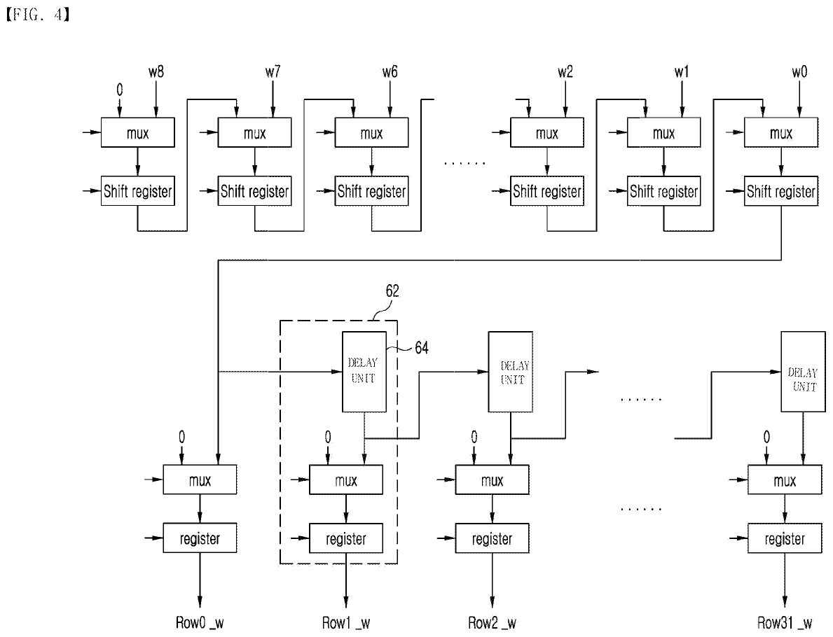

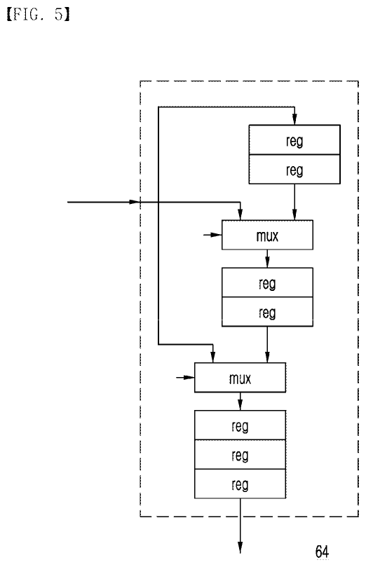

FIG. 4 illustrates a detailed internal configuration of the weight output unit according to the present invention, and FIG. 5 illustrates an internal configuration of the weight output block according to the present invention.

Referring to FIG. 4, when a kernel size is 3×3, W0 to W8 values are loaded and shifted from a kernel buffer 40, and the loaded W0 to W8 values are output as a first row weight (Row0_w).

A weight outputted from the first row is outputted to the second row weight (Row1_w) after 3 clocks are delayed through the delay unit 64. The weight outputted from the second row is delayed by three clocks through an adjacent delay unit 64, resulting in a delay of six clocks for the first row. This operation is repeated in each row, and as the row increases, a weighted value delayed by 3 clocks is continuously output.

Referring to FIG. 5, the delay unit 64 of the weight output block 62 may include a multiplexer MUX and a shift register. Through this configuration, the weight is delayed by three clocks and outputted.

If a kernel size is 5×5, two more shift registers are increased in the configuration of FIG. 5, and four more shift registers are increased in the case of a kernel size 7×7.

The above description is merely an exemplary description of the present invention, and various modifications can be made by a person with ordinary skills in the art to which the present invention belongs without departing from the technical idea of the present invention.

Accordingly, embodiments disclosed in the specification of the present invention are not limited to the present invention. The scope of the present invention shall be interpreted in accordance with the claims below, and all technologies within the same scope shall be interpreted as being included in the scope of the present invention.

### EXPLANATION OF THE SYMBOLS

| | | | |
|---|---|---|---|
| 10: | memory | 20: | DMA |
| 30: | data buffer | 40: | kernel buffer |
| 50: | data buffer | 60: | Weight output unit |
| 70: | MAC array processor | 72: | convolution operation block |

What is claimed is:

1. A depth-wise convolution accelerating device, the depth-wise convolution accelerating device comprising:
a MAC array processor;
a data output unit configured to receive data of each row of an image from a data buffer and input the data to a convolution operation block of the MAC array processor while shifting N−1 times according to a size of the kernel (N×N); and
a weight output unit configured to receive a kernel data from a kernel buffer and sequentially input a weight comprising kernel data to the convolution computation blocks of the MAC array processor, wherein the kernel data is inputted by delaying N clocks if the row increases as an N.

2. The depth-wise convolution accelerating device of claim 1, wherein the data output unit comprises a plurality of shift registers, which are arranged for each column and receives data of each row data of the image at the same time to shift the data.

3. The depth-wise convolution accelerating device of claim 1, wherein the weight output unit comprises a plurality of a weight output blocks, which are arranged on a row basis, receives kernel data, and outputs the kernel data in a first in first out (FIFO) method.

4. A MAC array processor, the MAC array processor comprising:
wherein the MAC array processor comprises a plurality of convolution operation blocks,
wherein the plurality of convolution operation blocks configured to input the same image data is simultaneously to the same column of the convolution operation blocks and the same kernel data is input to the plurality of the convolution operation blocks in the same row, and kernel data is input to the convolution operation blocks in each row delayed by the N clock according to the kernel size (N×N) of the previous row.

5. The MAC array processor of claim 4, wherein a “0” value is inputted to the convolution operation blocks having in each row before the input of kernel data begins or after input is completed.
